(19) United States
(12) Patent Application Publication
(10) Pub. No.: US 2005/0023718 A1
(43) Pub. Date: Feb. 3, 2005

(54) Apparatus and method for molding spacer fabric or lofted material

(75) Inventors: Thomas S. Wood, Morresville, NC (US); Roger D. Warren, Claremont, NC (US)

Correspondence Address: Charles N. J. Ruggiero, Esq.;Ohlandt, Greeley, Ruggiero & Perle, L.L.P., 10th Floor, One Landmark Square, Stamford, CT, 06901-2682, US

(73) Assignee: Sara Lee Corporation

(21) Appl. No.: 10/631,474

(22) Filed: Jul. 31, 2003

(51) Int. Cl. B29C 37/02; B29C 51/08

(52) U.S. Cl. 264/161; 425/398; 264/324

(57) ABSTRACT

An apparatus and a method for molding a lofted material and preserving the inherent loft characteristics associated with such a material are provided. The apparatus has a first mold and a second mold that cooperate to provide a three-dimensional aspect to the lofted material. The first mold has a surface with a projecting element and a first level portion while the second mold has a surface with a recessed element and a second level portion. The projecting element is formed to fit in the recessed element when the first and second molds are brought into relatively close relation. A uniform preset gap is maintained between the projecting element and the recessed element when the first mold is closed relative to said second mold, or vice-versa, such that the inherent loft characteristics associated with the lofted material are substantially preserved during a molding operation.

### BACKGROUND OF THE INVENTION

1. Field of the Invention

The present invention relates to an apparatus and method for molding garments or the like. More particularly, the present invention relates to an apparatus and method for molding a spacer fabric or lofted material to provide such fabric or material with a three dimensional shape.

2. Description of the Prior Art

Various methods and mechanisms for molding different types and assemblies of material have been developed and are known. For example, U.S. Pat. No. 3,464,418 provides an apparatus and method for making brassiere pads from bonded non-woven fibrous batting material, U.S. Pat. No. 4,025,597 provides a method of making a brassiere cup from a soft fibrous board material, U.S. Pat. No. 4,080,416 provides a method for making multi-layered seamless brassiere pads, and U.S. Pat. No. 4,250,137, which provides a process for preparing breast pads or fronts such that the pads are centrally soft and peripherally firmer.

Notwithstanding that which is known, there remains a continuing need for improved methods and/or devices for molding a spacer fabric or lofted material to provide a three dimensional shape thereto without compromising the loft characteristics associated with such material. Problems heretofore associated with various processes of molding a lofted material include at least the following: (1) thinning of material at points of increased pressure or applied heat, or both, such as for example, the apex of a bra cup or pad, (2) requiring relatively complicated or additional structural elements, or both to facilitate a desired result, for example, spacer devices or vacuum systems, and (3) requiring that heat, pressure or both be avoided at relatively substantial portions of the material being molded, which can complicate the molding process.

### SUMMARY OF THE INVENTION

It is an object of the present invention to provide an improved apparatus and method for molding a spacer fabric or lofted material.

It is another object of the present invention to provide an improved apparatus for molding a lofted material that can be adjusted to accommodate the loft of different materials.

It is a further object of the present invention to provide an improved apparatus for molding a lofted material that can be adjusted to provide different lofts to a variety of materials.

It is still another object of the present invention to provide an improved apparatus and method for molding a lofted material to provide a balance of comfort, support and durability.

These and other objects and advantages of the present invention are achieved by a molding apparatus with at least a first die or mold with a projecting element and a first level portion, and a second die or mold with a recessed element and a second level portion. The projecting element and the recessed element are formed such that when the first level portion of the first mold and the second level portion of the second mold are brought into relatively close relation, a uniform preset distance or gap is created between the projecting element and the recessed element. The gap is preferably adjustable to accommodate the loft of different materials. The first mold and second mold each are preferably selectively and/or independently heatable and configured as appropriate to facilitate the following material molding method.

The method for molding the lofted material essentially comprises the steps of first, positioning a lofted material or an assembly of lofted material in the molding apparatus. Then, closing the first mold in relation to the second mold, or vice-versa, sandwiching the lofted material therebetween such that the portion of the lofted material situated between the first and second level portions is compressed and the portion of the lofted material situated between the projecting element and recessed element is compressed only to the extent desired or not at all. The extent of compression being adjustable. Following this closing step is a step of opening the first mold in relation to the second mold after a period of selectively providing pressure and/or heat as appropriate for the desired molding result. The resulting molded lofted material preferably providing a balance of comfort, support and durability.

### BRIEF DESCRIPTION OF THE DRAWINGS

Other and further objects, advantages and features of the present invention will be understood by reference to the following specification in conjunction with the accompanying drawings, in which like reference characters denote like elements of structure.

FIG. 1 is a cross-sectional side view of an apparatus for molding a lofted material in accordance with an illustrative embodiment of the present invention with the apparatus shown in an open position;

FIG. 2 is a cross-sectional side view of the apparatus of FIG. 1 with the apparatus shown in a closed position;

FIG. 3 is a side sectional view of the apparatus of FIG. 1, reflecting a forming step in accordance with an illustrative embodiment of the present invention;

FIG. 4 is a side sectional view of an alternative apparatus for molding a lofted material;

FIG. 5 is a side sectional view of another alternative apparatus for molding a lofted material;

FIG. 6 is a plan view of yet another alternative apparatus for molding a lofted material;

FIG. 7 is a plan view of still another alternative apparatus for molding a lofted material; and

FIG. 8 is a side sectional view of yet still another alternative apparatus for molding a lofted material.

### DETAILED DESCRIPTION OF THE INVENTION

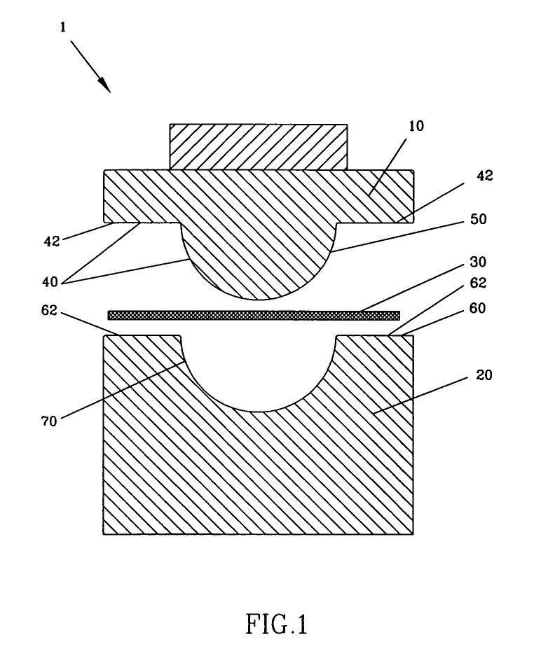

Referring to the drawings and, in particular to FIG. 1, there is shown an illustrative embodiment of an apparatus for molding a lofted material generally represented by reference numeral 1. The apparatus 1 preferably has at least two mold elements, a first mold 10 and a second mold 20. Preferably, the two molds are complementary to one another.

Preferably, first mold 10 and second mold 20 cooperate to mold or form a lofted material 30 positioned therebetween into a three-dimensional shape, such as, for example, that required by molded brassiere pads. Preferably, lofted material 30 can be any of a variety of materials or combination of materials (i.e., batting, foam, etc.) and can be fashioned into a variety of forms, such as for example, a garment or an upholstery item. The three-dimensional shape

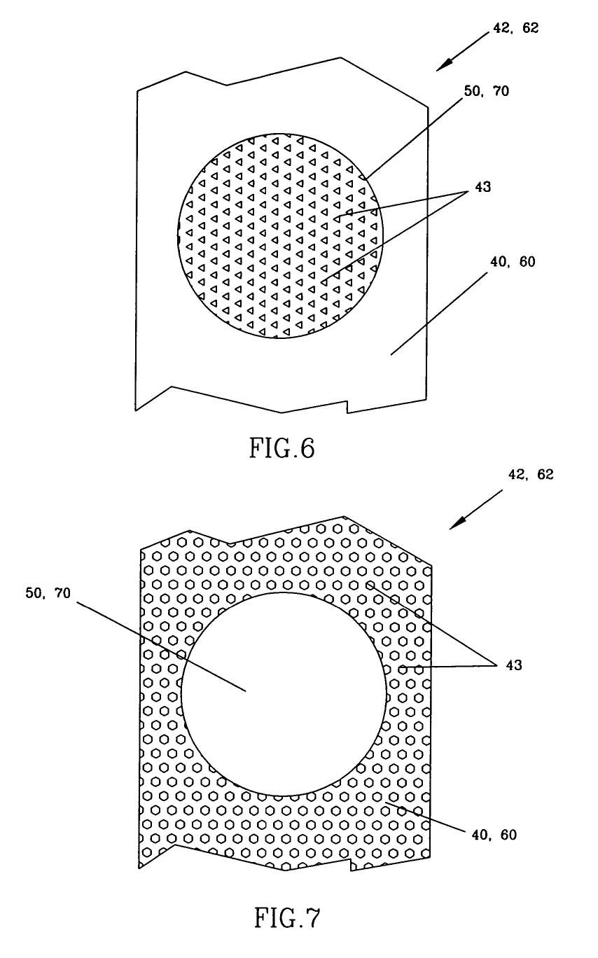

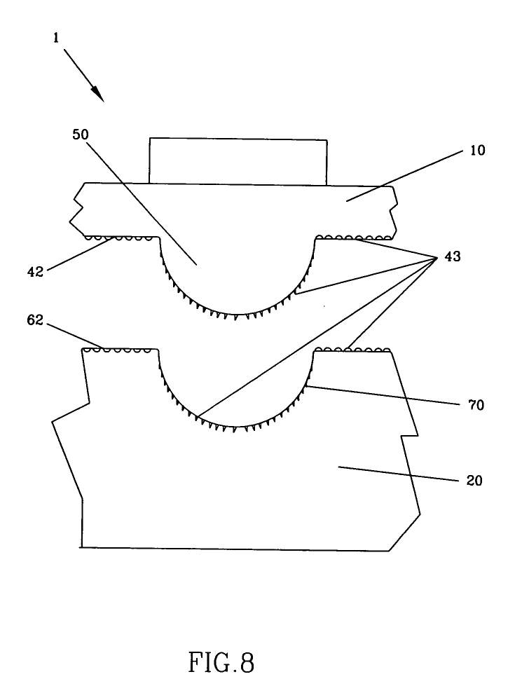

First mold 10 preferably has at least one first contact surface 40 with at least one projecting element 50 in the form of a dome. First contact surface 40 preferably also has a first level portion 42 about projecting element 50. First contact surface 40 may also have any of a variety of other surface elements 43 associated therewith, such as for example, nodes, dimples, and/or teeth as shown in FIGS. 6 through 8. First contact surface 40 can be interchangeably associated with first mold 10. First mold 10 can be interchangeably associated with apparatus 1. The interchangeability of first contact surface 40 and/or first mold 10 preferably provides apparatus 1 with further diversity in application or use.

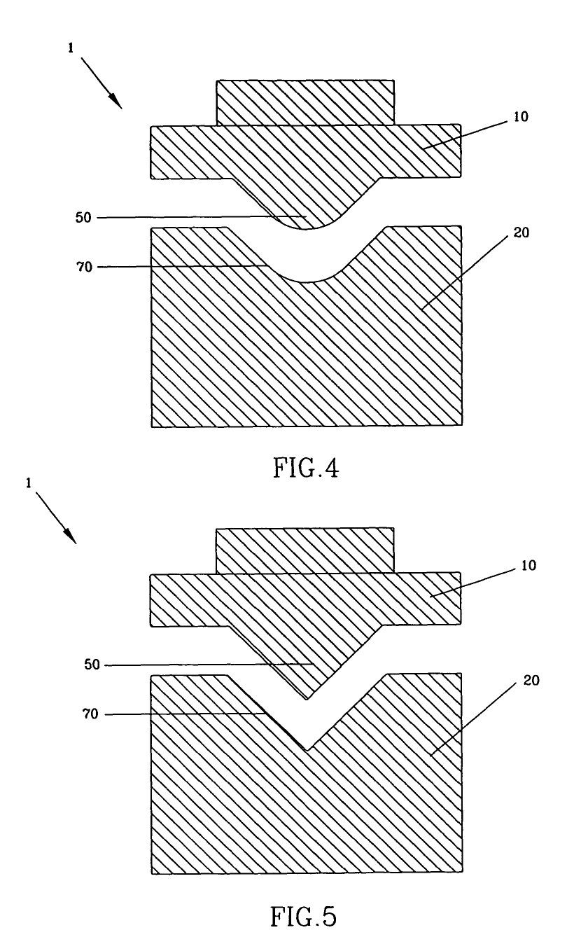

Preferably, first mold 10, first contact surface 40, projecting element 50, and/or first level portion 42 can be heatable. This heating can be accomplished in any of a variety of ways, such as for example, via electric heating wires or rods associated with first mold 10. These heating wires or rods could preferably conduct or transmit heat, via first mold 10, as appropriate to provide any and/or all of the aforementioned elements thereof with sufficient heat for effective molding under a variety of different molding parameters. First mold 10 can preferably have any shape, size, and/or configuration suitable for accomplishing one or more different molding operations. See, for example, FIGS. 4 and 5, which show alternative embodiments of first mold 10. It is noted that the present invention is not limited to those configurations discussed and/or shown and that other configurations are also within the scope of the present invention.

It is also noted, with regard to surface elements 43 discussed above, that surface elements 43 are preferably suitable for achieving a variety of different molding effects. For example, surface elements 43 can be disposed on either and/or both projecting element 50 and first level portion 42 to interact with lofted material 30 during a molding process. Surface elements 43 can be, for example, one or more piercing elements, heating or cooling elements, cushioning or insulating elements, or any combination of the same. Other similar types of elements may also be used and are within the scope of the present invention.

Referring again to FIG. 1, second mold 20 has at least one second contact surface 60 with at least one recessed element 70 in the form of a dish. Preferably, recessed element 70 is complementary to and cooperative with projecting element 50 of first mold 10. Second contact surface 60 preferably also has a second level portion 62 about recessed element 70. Second contact surface 60 may also have surface elements 43 associated therewith. Second contact surface 60 can be interchangeably associated with second mold 20, and, the second mold can be interchangeably associated with apparatus 1. The interchangeability of second contact surface 60 and/or second mold 20 preferably provides apparatus 1 with further diversity in application or use.

Preferably, second mold 20, second contact surface 60, recessed element 70, and/or second level portion 62 can be heatable. Such heating can be accomplished in any of a variety of ways, such as, for example, by electric heating wires or rods associated with second mold 20. These heating wires or rods could preferably conduct or transmit heat, via second mold 20, as appropriate to provide any and/or all of the aforementioned elements thereof with sufficient heat for effective molding under a variety of different molding parameters. Second mold 20 can preferably have any shape, size, and/or configuration suitable for accomplishing one or more different molding operations in cooperation with mold 10. See, for example, FIGS. 4 and 5, which show alternative embodiments of second mold 20. It is noted that the present invention is not limited to those configurations discussed and/or shown and that other configurations are also within the scope of the present invention.

As with the first mold 10, surface elements 43 for providing a variety of different molding effects that can be disposed on either and/or both recessed element 70 and second level portion 62 to interact with lofted material 30 during the molding process.

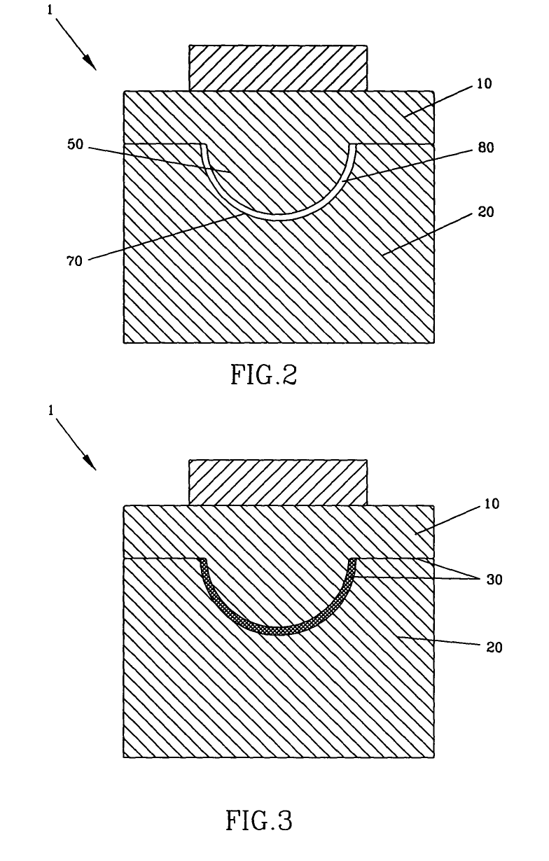

Referring to FIGS. 2 and 3, having described some of the preferred elements of an illustrative embodiment of the present invention, first and second molds 10, 20, respectively, are preferably configured to engage one another such that when first level portion 42 of first mold 10 and second level portion 62 of second mold 20 are brought into relatively close relation, a uniform preset distance or gap 80 is created between projecting element 50 and recessed element 70. Gap 80 preferably has an extent of about 0.1 inches. However, gap 80 can also have any extent appropriate for accomplishing a desired molding operation. Hence, gap 80 can preferably be adjusted to accommodate the loft characteristics associated with a variety of different materials. This adjusting feature can be accomplished in different ways, such as, for example, via the preferred interchangeability of first and second molds 10, 20 and/or first and second contacting surfaces 42, 62. Gap 80 may also be adjusted to influence the degree of loft associated with a material. That is, gap 80 can be reduced to provide a desired finish or effect to a loft material. Thus, it is apparent the preservation of the inherent loft characteristics associated with a lofted material is preferably independent of the heat, pressure and/or time associated with a particular molding process. The present invention efficiently and effectively preserves the inherent loft characteristics associated with a loft material during the molding process.

The process of molding lofted material 30 preferably includes at least the following steps. Referring to FIG. 1, lofted material 30 is first positioned in apparatus 1 between first mold 10 and second mold 20. Referring to FIG. 2, first mold 10 is then closed in relation to second mold 20, or vice-versa, to sandwich lofted material 30 therebetween. Preferably, at least a portion of lofted material 30 is situated in gap 80 so that the inherent loft characteristics thereof are substantially preserved while at least another portion of lofted material 30 is substantially compressed between first and second level portions 42, 62 of first and second contact surfaces 40, 60, respectfully. Next, first mold 10 is opened in relation to second mold 20, or vice-versa, after an appropriate amount of heat and/or pressure has been applied for an appropriate period of time. Then, the molded lofted material is removed from apparatus 1 to perform any additional operations required for obtaining a desired effect, such as for example, eliminating any excess or unwanted material as appropriate to leave lofted material with a three dimensional shape.

The present invention having been thus described with particular reference to the preferred forms thereof, it will be obvious that various changes and modifications may be made therein without departing from the spirit and scope of the present invention as defined herein.

1. An apparatus for molding a lofted material, comprising:
a first mold having a surface with a projecting element and a first level portion;
a second mold having a surface with a recessed element and a second level portion; and
means for moving said first and second molds towards and away from each other,
wherein said projecting element of said first mold and said recessed element of said second mold are positioned so that a uniform preset gap is defined between said projecting element and said recessed element when said first level portion of said first mold and said second level portion of said second mold are brought into relatively close relation.

2. The apparatus of claim 1, wherein said uniform preset gap is about 0.1 inches.

3. The apparatus of claim 1, wherein said uniform preset gap is maintained only where said projecting element and said recessed element interact with each other.

4. The apparatus of claim 3, wherein said uniform preset gap ceases to be maintained where said first and second level portions interact with each other.

5. The apparatus of claim 1, wherein said uniform preset gap is adjustable to accommodate a variety of different materials.

6. The apparatus of claim 1, wherein said first mold and said second mold are heatable.

7. The apparatus of claim 1, wherein said first level portion and said second level portion are independently and selectively heatable.

8. The apparatus of claim 7, wherein said projecting element and said recessed element are independently and selectively heatable.

9. The apparatus of claim 1, wherein said first mold, said second mold, or both have one or more surface elements.

10. The apparatus of claim 9, wherein said one or more surface elements of said first mold are associated with said projecting element.

11. The apparatus of claim 9, wherein said one or more surface elements of said second mold are associated with said recessed element and formed to interact with said one or more surface elements of said first mold.

12. The apparatus of claim 9, wherein said one or more surface elements are heatable.

13. A method for molding a lofted material comprising the steps of:
positioning a lofted material in a molding apparatus having at least a first mold and a second mold, said first mold having a surface with a projecting element and a first level portion and said second mold having a surface with a recessed element and second level portion, said projecting element being formed to fit in said recessed element when said first mold and said second mold are brought into relatively close relation;
closing together said first mold and said second mold thereby sandwiching said lofted material between said first level portion and said second level portion while maintaining a uniform preset gap between said projecting element and said recessed element so that the inherent loft characteristics of said lofted material are substantially preserved; and
opening in relation to each other said first mold and said second mold, or vice-versa, and removing the molded lofted material from said apparatus.

14. The method of claim 13, further comprising the step of:
eliminating any excess material as appropriate to leave a molded lofted material with a three dimensional shape.

15. The method of claim 13, wherein said first mold, said second mold, or both are independently and selectively heatable.

16. The method of claim 13, wherein said projecting element, said recessed element, or both are independently and selectively heatable.

17. The method of claim 13, wherein said first mold, said second mold, or both have one or more surface elements.

18. The method of claim 17, wherein said one or more surface elements of said first mold are associated with said projecting element, and wherein said one or more surface elements of said second mold are associated with said recessed element to interact with said one or more surface elements of said first mold.

19. The method of claim 17, wherein said one or more surface elements are heatable.

20. The method of claim 17, wherein said one or more surface elements are uniformly distributed over said first mold, said second mold, or both.
